(19) United States
(12) Patent Application Publication
(10) Pub. No.: US 2018/0255711 A1
(43) Pub. Date: Sep. 13, 2018

(54) GREEN WALL WITH OVERLAPPING HEXAGONAL SHAPED MODULES ON A VERTICAL STRUCTURE

(71) Applicant: Board of Regents, The University of Texas System, Austin, TX (US)

(72) Inventors: Mark Simmons, (US); Danelle Briscoe, Austin, TX (US)

(21) Appl. No.: 15/761,921

(22) PCT Filed: Sep. 21, 2016
(86) PCT No.: PCT/US2016/052880

§ 371 Date: Mar. 21, 2018

Related U.S. Application Data
(60) Provisional application No. 62/235,932, filed on Oct. 1, 2015.

(51) Int. Cl. A01G 9/02; A01G 27/00

(52) U.S. Cl. CPC A01G 9/025; E04H 6/08; A01G 27/00

(57) ABSTRACT

A green wall that is designed to be utilized in warmer climates, such as subtropical and tropical climates, by utilizing hexagonal shaped modules for housing soil and vegetation. These hexagonal shaped modules overlap one another on a vertical structure (e.g., trellis) in such a manner as to shade underneath modules. Furthermore, these hexagonal shaped modules are slanted downward to aid in soil volume and thermal reduction as well as to keep roots cool and maximize water availability. The green wall additionally includes a water delivery system integrated with the modules, where excess water from module saturation percolates to the module immediately below. In this manner, green walls can be successful in warmer climates with greater soil volume and thermal reduction.

### CROSS REFERENCE TO RELATED APPLICATIONS

This application claims priority to U.S. Provisional Patent Application Ser. No. 62/235,932, entitled “Green Wall with Overlapping Hexagonal Shaped Modules on a Vertical Structure to Shade Underneath Modules as well as to Keep Roots Cool and Maximize Water Availability,” filed Oct. 1, 2015, which is incorporated by reference herein in its entirety.

### TECHNICAL FIELD

The present invention relates generally to green walls, and more particularly to a green wall with overlapping hexagonal shaped modules to shade underneath modules as well as to keep roots cool and maximize water availability.

### BACKGROUND

A green wall is a wall partially or completely covered with greenery that includes a growing medium, such as soil. Most green walls also feature an integrated water delivery system. Green walls are also known as living walls or vertical gardens.

Green walls provide many benefits, including cooling buildings, improving air and water quality, providing habitat for wildlife (e.g., birds), reducing noise and providing aesthetic benefits.

Green walls may be indoors or outside, freestanding or attached to an existing wall, and come in a great variety of sizes. As of 2015, the largest green wall covers 2,700 square meters (29,063 square feet or more than half an acre) and is located at the Los Cabos International Convention Center, a building designed by Mexican architect Fernando Romero for the 2012 G-20 Los Cabos summit.

Green walls have seen a recent surge in popularity. Of the 61 large-scale outdoor green walls listed in an online database provided by greenroof.com, 80% were constructed in or after 2009 and 93% dated from no later than 2007. Many Iconic green walls have been constructed by institutions and in public places, such as airports (e.g., Edmonton International Airport, Chhatrapati Shivaji International Airport in Mumbai, India), and are now becoming common, to improve the aesthetics.

Currently though most green walls are designed for temperate climates as opposed to warmer climates (e.g., subtropical, tropical). As a result, green walls in hot climates have had limited success as far as enabling a wall that can continue to be covered with vegetation due to high evaporation rates. Typically, the green walls in hot climates suffer from limited soil volume and limited thermal reduction (e.g., reduction of carbon dioxide admissions).

### SUMMARY

In one embodiment of the present invention, a green wall comprises a plurality of hexagonal shaped modules overlapping one another on a vertical structure in such a manner as to shade underneath modules, where the plurality of modules are used to house soil and vegetation. Each of the plurality of modules is slanted downward. Furthermore, the green wall comprises a water delivery system integrated with the plurality of modules, where excess water from module saturation percolates to modules immediately below.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates a green wall configured in accordance with an embodiment of the present invention;

FIG. 2 is a vertical structure corresponding to a trellis of hexagonal openings in accordance with an embodiment of the present invention;

FIG. 3 illustrates modules overlapping one another on the vertical structure in such a manner as to shade the underneath modules in accordance with an embodiment of the present invention;

FIG. 4 illustrates three possible configurations for modules based on the plant type to be housed in the module and the type of object, or lack of an object, set against the end of the module in accordance with an embodiment of the present invention;

FIG. 5A illustrates a top view of the module for a particular type of configuration in accordance with an embodiment of the present invention;

FIG. 5B illustrates a side view of the module for a particular type of configuration in accordance with an embodiment of the present invention; and

FIG. 5C illustrates a top-side view of the module for a particular type of configuration in accordance with an embodiment of the present invention.

### DETAILED DESCRIPTION

While the following discusses the present invention in connection with a green wall attached to a parking garage, the green wall of the present invention may be attached to other structures. Furthermore, the green wall of the present invention may be indoors or outside as well as freestanding. A person of ordinary skill in the art would be capable of applying the principles of the present invention to such implementations. Further, embodiments applying the principles of the present invention to such implementations would fall within the scope of the present invention.

The present invention provides a green wall that is designed to be utilized in warmer climates, such as subtropical and tropical climates, by utilizing hexagonal shaped modules for housing soil and vegetation. These hexagonal shaped modules overlap one another on a vertical structure (e.g., trellis) in such a manner as to shade underneath modules. Furthermore, these hexagonal shaped modules are slanted downward to aid in soil volume and thermal reduction as well as to keep roots cool and maximize water availability. The hexagonal shaped modules may be slanted at an angle (e.g., thirty degrees) designed to optimize plant growth based on the type of plant housed in the module. Additionally, excess water from module saturation may percolate to the module immediately below. In this manner, green walls can be successful in warmer climates with greater soil volume and thermal reduction.

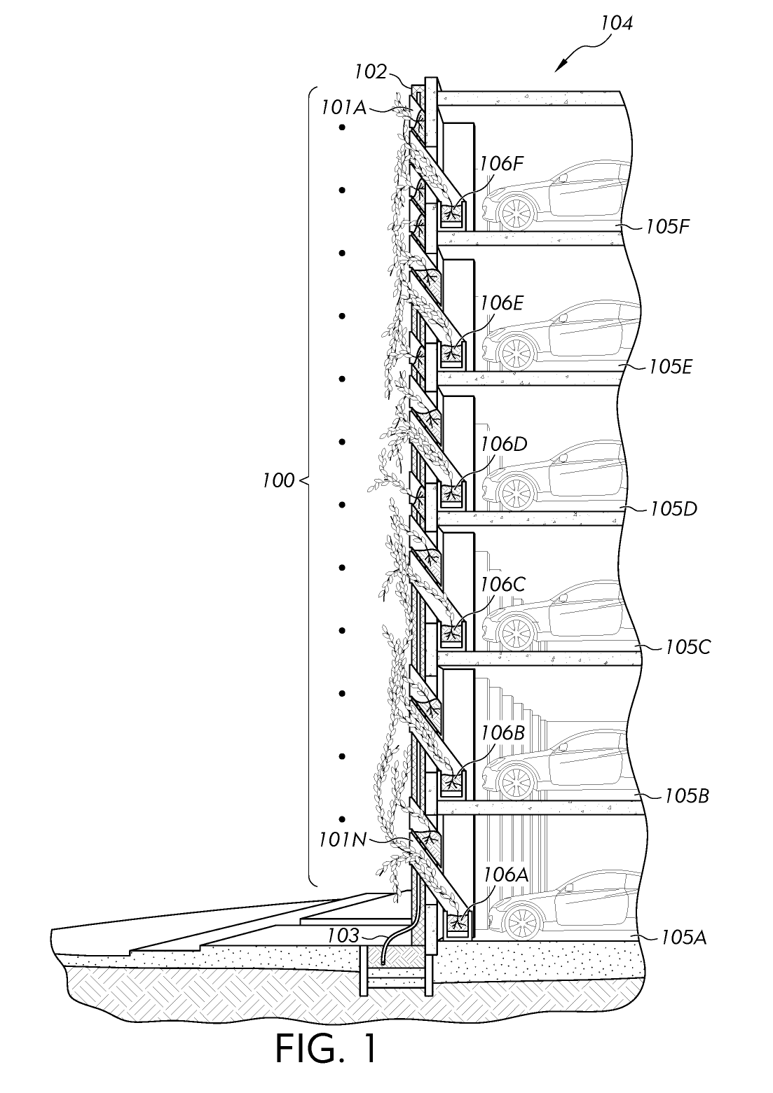

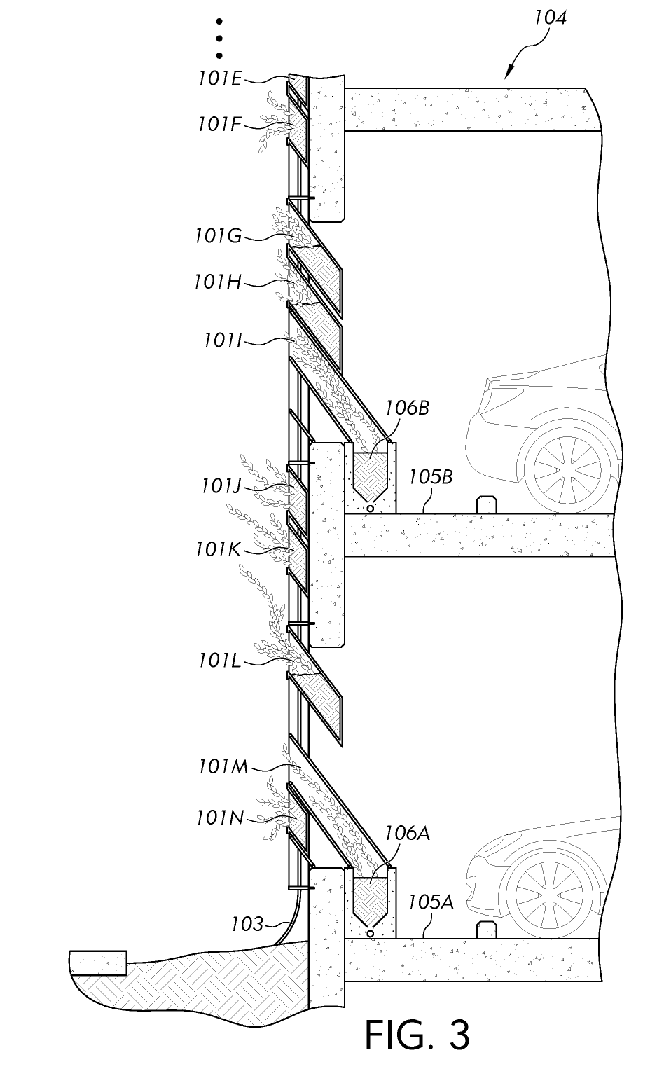

Referring now to the Figures in detail, FIG. 1 illustrates a green wall 100 that includes modules 101A-101N for housing soil and vegetation (FIG. 1 only specifically identifies modules 101A, 101N; however, as shown in FIG. 3, there are numerous modules overlapping one another on vertical structure 102), where N is a positive integer number, overlapping one another on a vertical structure 102 in such a manner as to shade the underneath modules in accordance with an embodiment of the present invention. Modules 101A-101N may collectively or individually be referred to as modules 101 or module 101, respectively. Green wall 100 may include any number of modules 101 and the principles of the present invention are not to be limited in scope to utilizing any particular number of modules 101 in green wall 100. A more detailed description of modules 101 is provided below in connection with FIGS. 3-4 and 5A-5C.

Each of these modules 101 may house different types of plantation based on the amount of soil housed by module 101. As discussed further herein, modules 101 may be fabricated in many sizes and therefore house different amounts of soil to facilitate different root depths. Furthermore, to aid in growing a green wall 100 in hot climates, such as subtropical and tropical climates, plantation suitable for such climates would be selected. Different types of plantation may be selected to be grown in modules 101 based on many factors, such as drought tolerance, ecological distribution, size, soil drainage, moisture, etc.

In one embodiment, each module 101 may be assigned a certain plant species.

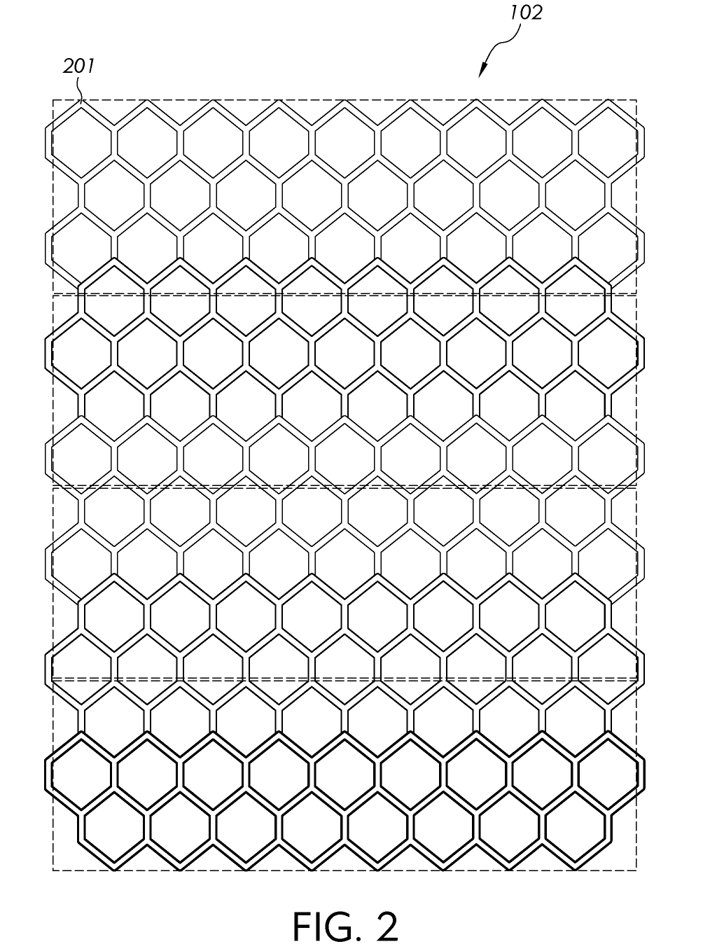

As discussed above, modules 101 may overlap one another on a vertical structure 102. An embodiment of such a vertical structure 102 is shown in FIG. 2 in accordance with an embodiment of the present invention.

Referring to FIG. 2, vertical structure 102 may correspond to a trellis of hexagonal openings 201, where each hexagonal opening 201 may be used to attach module 101 with a hexagonal shape as discussed further below.

Returning to FIG. 1, green wall 100 may further include a water delivery system 103 integrated with modules 101 with a design that allow excess water from module saturation to percolate to modules 101 immediately below.

In one embodiment, vertical structure 102 of green wall 100 is attached to a parking garage 104, where at each level (or horizontal platform) 105A-105F of parking garage 104 used for parking, a subset of modules 101 are connected to a planting container 106A-106F located on horizontal platform 105A-105F, respectively, adjacent to vertical structure 102. Horizontal platforms 105A-105F may collectively or individually be referred to as horizontal platforms 105 or horizontal platform 105, respectively. Planting containers 106A-106F may collectively or individually be referred to as planting containers 106 or planting container 106, respectively. While FIG. 1 illustrates some modules 101 of green wall 100 being connected to a planting container 106, the principles of the present invention are not to be limited in scope to such a design. Green wall 100 may include the overlapping of modules 101 on vertical structure 102 without any modules 101 being connected to planting container 106.

Referring now to FIG. 3, FIG. 3 illustrates modules 101A-101N (FIG. 1) overlapping one another on vertical structure 102 of FIG. 1 (not shown in FIG. 3 so as to aid the understanding of modules 101) in such a manner as to shade the underneath modules 101 in accordance with an embodiment of the present invention. As illustrated in FIG. 3, modules 101 are slanted in a downward direction, such as to the right. While FIG. 3 illustrates modules 101 slanting downward to the right direction, the principles of the present invention are not to be limited in such a manner and to include modules 101 slanting downward to the left direction. In one embodiment, the angle (e.g., thirty degrees) of the slant may correspond to the angle that optimizes plant growth based on the type of plant housed in the module. As will be discussed in further detail below, by designing modules 101 with a downward slant, roots of the vegetation housed in modules 101 are kept cool as well as maximize the water availability. Furthermore, by designing modules 101 with a downward slant, excess water from module saturation may be able to percolate to modules 101 immediately below.

As illustrated in FIG. 3, modules 101 are integrated with a water delivery system 103 to provide water to the vegetation being housed in modules 101.

As further illustrated in FIG. 3, a subset of the modules 101 (e.g., modules 101I, 101M) are connected to a planting container 106 (e.g., planting containers 106B, 106A, respectively) located on horizontal platform 105 (e.g., horizontal platforms 105B, 105A, respectively), such as a level of a parking garage 104. While FIG. 3 illustrates modules 101I, 101M of green wall 100 being connected to planting container 106B, 106A, respectively, the principles of the present invention are not to be limited in scope to such a design. Green wall 100 may include an overlapping of modules 101 on vertical structure 102 without any modules 101 being connected to planting container 106.

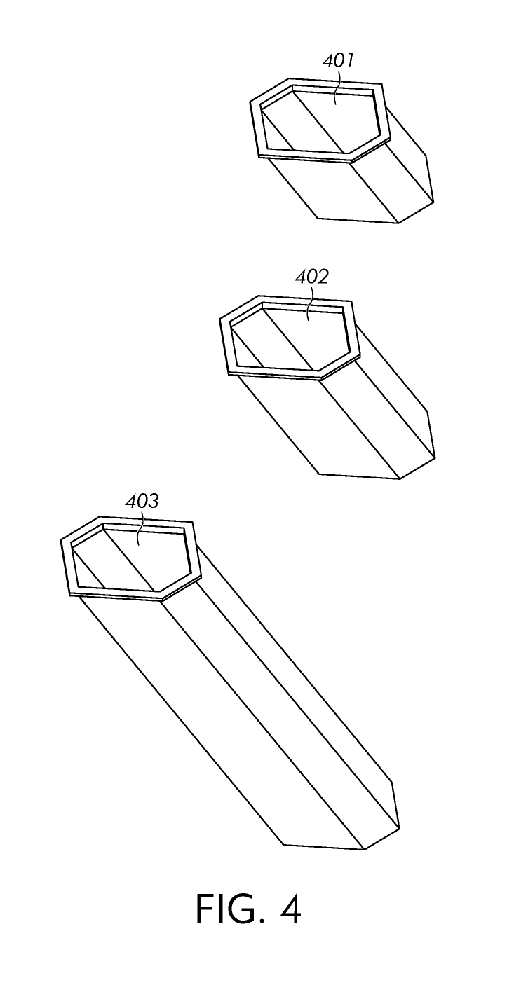

In one embodiment, modules 101 may exhibit one of three different configurations as shown in FIG. 4. FIG. 4 illustrates three possible configurations 401-403 for modules 101 (FIGS. 1 and 3) based on the plant type to be housed in module 101 and the type of object (e.g., concrete wall, planting container 106), or lack of an object (e.g., open air), set against the end of module 101 in accordance with an embodiment of the present invention. In one embodiment, each configuration 401, 402, 403 utilizes a hexagonal shape with the only difference between the configurations being the length of the downward slant of module 101. Such hexagonal shapes allow each module 101 to be nested in vertical structure 102 in such a manner as to address challenges, such as root temperature tolerance and limited water availability. In one embodiment, the length of the downward slant of configuration 403 exceeds the length of the downward slant of configuration 402 which exceeds the length of the downward slant of configuration 401.

For example, referring to FIG. 4, in conjunction with FIG. 3, configuration 401 with the shortest length of the downward slant may be utilized for modules 101E, 101F, 101J, 101K, 101N since the ends of such modules 101 are set against a concrete wall or other obstruction. Configuration 402 may be utilized for modules 101G, 101H, 101L since the ends of such modules 101 are set against the open air. Furthermore, configuration 403 with the largest length of the downward slant may be utilized for modules 101I, 101M since the ends of such modules 101 are set against planting container 106B, 106A, respectively, on horizontal platform 105B, 105A, respectively.

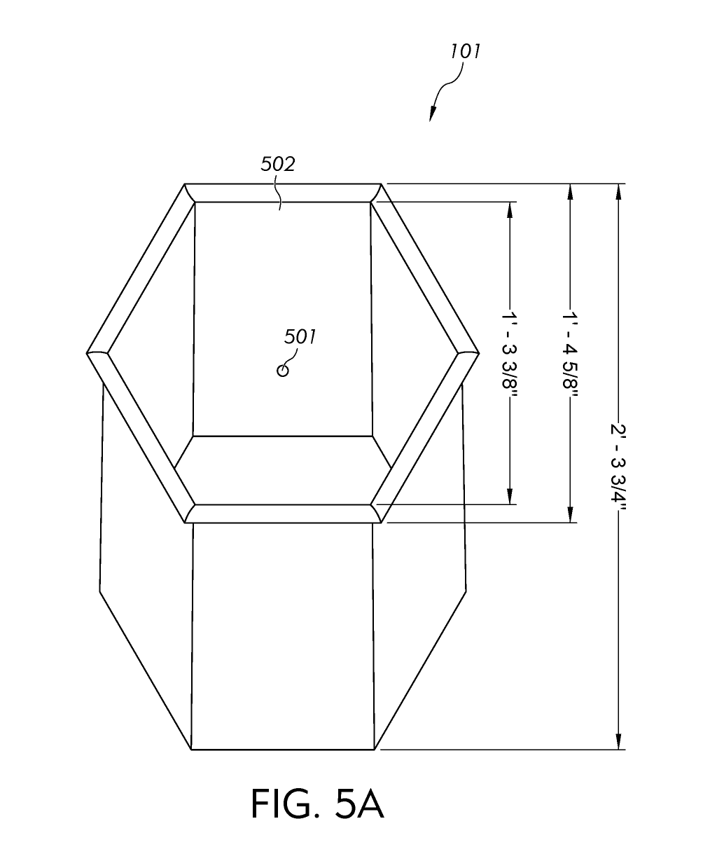

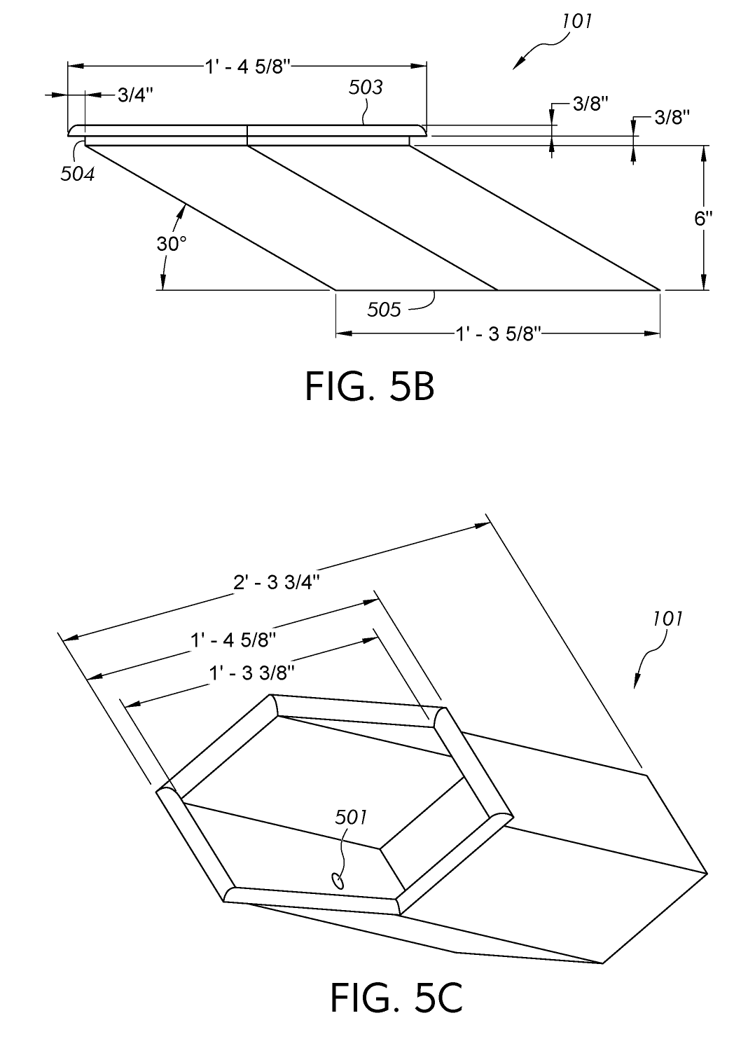

An illustration of the dimensions of configuration 402 is shown in FIGS. 5A-5C.

Referring to FIG. 5A in conjunction with FIG. 4, FIG. 5A illustrates a top view of module 101 for configuration 402 in accordance with an embodiment of the present invention. As illustrated in FIG. 5A, module 101 has a horizontal width opening for plantation of approximately 15 and ⅜ inches. In one embodiment, the horizontal width opening for plantation for configuration 402 corresponds to the same horizontal width opening for plantation for configurations 401, 403.

Furthermore, as illustrated in FIG. 5A, module 101 has an end-to-end horizontal width opening (including the rim) of approximately 16 and ⅝ inches. In one embodiment, the end-to-end horizontal width opening for configuration 402 corresponds to the same end-to-end horizontal width opening for configurations 401, 403.

Furthermore, as illustrated in FIG. 5A, the length of the downward slant of configuration 402 corresponds to 27 and ¾ inches.

Additionally, as illustrated in FIG. 5A, a hole 501 is provided in the inner housing 502 of module 101 to integrate the water delivery system 103 (FIGS. 1 and 3) with module 101.

FIG. 5B illustrates a side view of module 101 for configuration 402 in accordance with an embodiment of the present invention. Referring to FIG. 5B, in conjunction with FIG. 4, in one embodiment, the rim 503 of module 101 has a thickness of approximately ⅜ of an inch. In one embodiment, rim 503 of module 101 extends outward beyond the inner support 504 (also with a thickness of approximately ⅜ of an inch) of module 101, such as by ¾ of an inch as shown in FIG. 5B. Furthermore, as illustrated in FIG. 5B, in one embodiment, module 101 is slanted downward by a thirty (30) degree angle. In one embodiment, modules 101 with configurations 401, 403 are also slanted downward by a thirty (30) degree angle.

Furthermore, in one embodiment, FIG. 5B illustrates that the base 505 of module 101 has a horizontal length of approximately 15 and ⅝ inches. Additionally, the distance from base 505 to inner support 504 of module 101 is approximately 6 inches.

FIG. 5C illustrates a top-side view of module 101 for configuration 402 in accordance with an embodiment of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A green wall, comprising:
a plurality of hexagonal shaped modules overlapping one another on a vertical structure in such a manner as to shade underneath modules, wherein said plurality of modules are used to house soil and vegetation, wherein each of said plurality of modules is slanted downward; and
a water delivery system integrated with said plurality of modules, wherein excess water from module saturation percolates to modules immediately below.

2. The green wall as recited in claim 1, wherein each of a subset of said plurality of modules is connected to a planting container located on a horizontal platform adjacent to said vertical structure.

3. The green wall as recited in claim 1, wherein each of said plurality of modules is slanted downward towards a right side.

4. The green wall as recited in claim 1, wherein each of said plurality of modules is slanted downward towards a left side.

5. The green wall as recited in claim 1, wherein each of said plurality of modules is slanted downward at a thirty degree angle.

6. The green wall as recited in claim 1, wherein one or more of said plurality of modules has a horizontal width opening for plantation of approximately 15 and ⅜ inches.

7. The green wall as recited in claim 1, wherein one or more of said plurality of modules has an entire downward length of approximately 27 and ¾ inches.

8. The green wall as recited in claim 1, wherein one or more of said plurality of modules has an end-to-end horizontal width of approximately 16 and ⅝ inches.

9. The green wall as recited in claim 1, wherein one or more of said plurality of modules is slanted at a thirty degree angle.

10. The green wall as recited in claim 1, wherein said vertical structure comprises a trellis of hexagonal openings.

11. The green wall as recited in claim 10, wherein said vertical structure is connected to a parking garage.

12. The green wall as recited in claim 1, wherein one or more of said plurality of modules are configured in a different configuration in comparison to other modules of said plurality of modules based on a plant type to be housed in said one or more of said plurality of modules.

13. The green wall as recited in claim 12, wherein one or more of said plurality of modules are configured in a different configuration in comparison to other modules of said plurality of modules based on a type of object or lack of said object set against an end of said one or more of said plurality of modules.
